(19) United States
(12) Patent Application Publication
(10) Pub. No.: US 2025/0046306 A1
(43) Pub. Date: Feb. 6, 2025

(54) SOUND ANALYSIS DEVICE, SOUND ANALYSIS METHOD, AND RECORDING MEDIUM

(71) Applicant: NEC Corporation, Minato-ku, Tokyo (JP)

(72) Inventors: Akira GOTOH, Tokyo (JP); Shuji KOMEIJI, Tokyo (JP); Yuko NAKANISHI, Tokyo (JP); Daichi NISHII, Tokyo (JP)

(73) Assignee: NEC Corporation, Minato-ku, Tokyo (JP)

(21) Appl. No.: 18/714,182

(22) PCT Filed: Nov. 30, 2022
(86) PCT No.: PCT/JP2022/044091

§ 371 Date: May 29, 2024

(30) Foreign Application Priority Data
Dec. 16, 2021 (JP) 2021-204070

(51) Int. Cl. G10L 15/22; G10L 25/48; G10L 25/84

(52) U.S. Cl. CPC G10L 15/22; G10L 25/48; G10L 25/84; G10L 2015/228

(57) ABSTRACT

The present invention assists a report receiver in swiftly and exactly handling an event. A specification unit specifies, in an input sound signal, a non-voice time in which a reporter who reports the occurrence of the event does not speak, an identification unit identifies a sound source at the occurrence site of the event by analyzing the sound signal in the non-voice time, and a prediction unit predicts a sound scene at the occurrence site of the event on the basis of the identified sound source.

### TECHNICAL FIELD

The present invention relates to a sound analysis device, a sound analysis method, and a program, and for example, relates to a sound analysis device, a sound analysis method, and a program for analyzing a sound signal on a notifier side when an incident is notified.

### BACKGROUND ART

Telephone numbers for emergency notifications are set for each country or region, such as 110 or 119 in Japan and the like, 911 in the United States and Canada, 000 in Australia, 999 in the United Kingdom, and 112 or 110 in Germany. When there is an emergency notification (hereinafter, simply referred to as notification) from a notifier, an operator or a recipient of a command center confirms the type (case or accident) of an incident, a place of occurrence of the incident, a time of occurrence of the incident, and the like to the notifier, and inquires of the notifier about the situation and environment of an occurrence site of the incident. Then, the recipient uses a terminal or the like of the command center that issues a command to a paramedic, to input the information on the incident gotten from the notifier to a command system. PTL 1 discloses an emergency activity support system that supports emergency activities.

The emergency activity support system described in PTL 1 converts a voice included in a sound signal into text data. Then, the emergency activity support system records the text data and displays a sentence corresponding to the text data on the terminal. As a result, the exchange between the recipient and the notifier can be stored without errors.

### CITATION LIST

### Patent Literature

PTL 1: JP 2021-93228 A

PTL 2: WO 2021/014649 A1

PTL 3: WO 2020/184631 A1

### SUMMARY OF INVENTION

### Technical Problem

A recipient may not be able to successfully communicate with the notifier because an incident is complex or the notifier is confused. There may be a situation where the notifier cannot speak. In such a case, it is difficult for the recipient to quickly and accurately deal with (respond to) an incident, such as commanding a paramedic, only from the conversation with the notifier.

The present invention has been made in view of the above problems, and an object of the present invention is to help a recipient of a notification quickly and accurately handle an incident.

### Solution to Problem

A sound analysis device according to an aspect of the present invention includes: a specification means for specifying a non-voice time during which a notifier who notifies occurrence of an incident is not speaking in an input sound signal; an identification means for identifying a sound source at an occurrence site of the incident by analyzing the sound signal in the non-voice time; and a prediction means for predicting a sound scene at the occurrence site of the incident based on the identified sound source.

A sound analysis method according to an aspect of the present invention includes: specifying a non-voice time during which a notifier who notifies occurrence of an incident is not speaking in an input sound signal; identifying a sound source at an occurrence site of the incident by analyzing the sound signal in the non-voice time; and predicting a sound scene at the occurrence site of the incident based on the identified sound source.

A non-transitory recording medium stores a program for causing a computer to execute: specifying a non-voice time during which a notifier who notifies occurrence of an incident is not speaking in an input sound signal; identifying a sound source at an occurrence site of the incident by analyzing the sound signal in the non-voice time; and predicting a sound scene at the occurrence site of the incident based on the identified sound source.

### Advantageous Effects of Invention

According to one aspect of the present invention, it is possible to assist a recipient of notification to quickly and accurately handle an incident.

### BRIEF DESCRIPTION OF DRAWINGS

FIG. 1 is a diagram schematically illustrating an example of a configuration of a command system to which a sound analysis device according to any one of first to fourth example embodiments is applicable.

FIG. 2 is a block diagram illustrating a configuration of a sound analysis device according to a first example embodiment.

FIG. 3 is a flowchart illustrating an operation of the sound analysis device according to the first example embodiment.

FIG. 4 is a block diagram illustrating a configuration of a sound analysis device according to a second example embodiment.

FIG. 5 illustrates an example of information indicating a situation, an environment, and an action of a person at an occurrence site of an incident.

FIG. 6 is a flowchart illustrating an operation of the sound analysis device according to the second example embodiment.

FIG. 7 is a block diagram illustrating a configuration of a sound analysis device according to a third example embodiment.

FIG. 8 is a flowchart illustrating an operation of the sound analysis device according to the third example embodiment.

FIG. 9 is a block diagram illustrating a configuration of a sound analysis device according to a fourth example embodiment.

FIG. 10 is a flowchart illustrating an operation of the sound analysis device according to the fourth example embodiment.

FIG. 11 is a diagram illustrating an example of a hardware configuration of the sound analysis device according to the first to fourth example embodiments.

### EXAMPLE EMBODIMENT

Example embodiments of the present invention will be described below with reference to the drawings.

### Command System

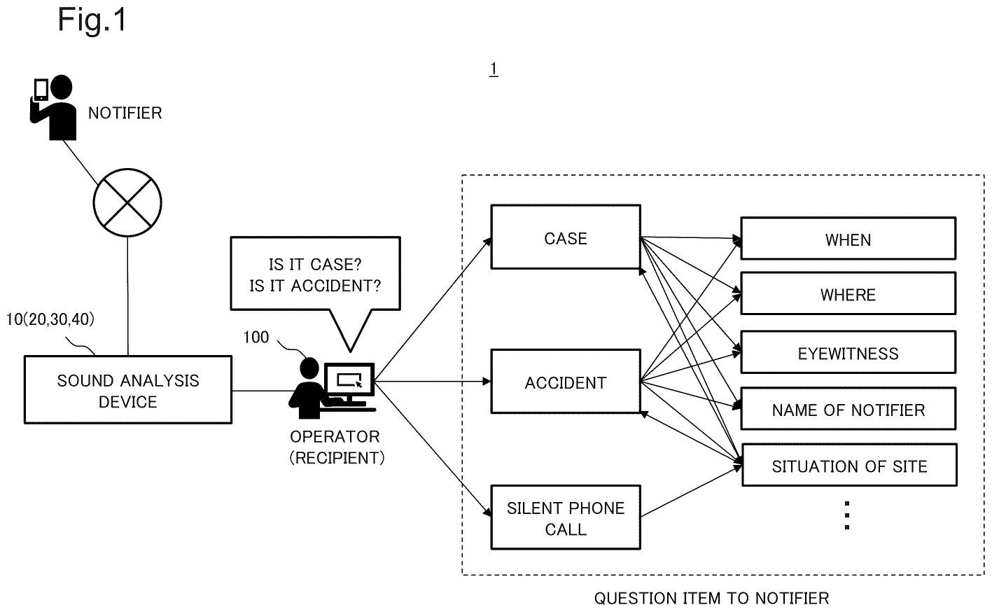

With reference to FIG. 1, a command system I to which any one of sound analysis devices 10, 20, 30, and 40 according to first to fourth example embodiments to be described later is applicable will be described. In the command system 1, a command is used to receive a report, command a site, and support an emergency activity in an emergency activity for the purpose of fire, rescue, relief, accident handling, security maintenance, and the like. FIG. 1 is a diagram schematically illustrating an example of a configuration of the command system 1.

As illustrated in FIG. 1, the command system 1 includes a sound analysis device 10 (20, 30, 40) and an office automation (OA) terminal 100 used by an operator (recipient). Here, the “sound analysis device 10 (20, 30, 40)” means any one of sound analysis devices 10, 20, 30, and 40 according to first to fourth example embodiments described later.

The OA terminal 100 includes a phone, an input device, a speaker, a personal computer, a display, a monitor, and the like. The OA terminal 100 is connected to the sound analysis device 10 (20, 30, 40) via a local area network (LAN) of the command system 1.

The OA terminal 100 is configured such that a notifier who notifies an incident and the operator (recipient) can talk with each other through the sound analysis device 10 (20, 30, 40). The incidents include accidents such as traffic accidents and emergency diseases, as well as cases such as fire, flood damage, blackout, other disasters, appearance of wild animals, and crime. Generally, an emergency, fire, or police handling target is the incident here.

In FIG. 1, an example of question items from the operator (recipient) to the notifier is described on the right side of the OA terminal 100. For example, the question items to the notifier include the type of the incident. The question items to the notifier include “when” and “where” the incident occurred, and confirmation of the presence or absence of “eyewitness” of the incident, “name of the notifier”, and “situation of the site”. Depending on the details (for example, whether it is an automobile accident or a pedestrian accident) of the type of the incident, the question item to the notifier may differ from that illustrated in FIG. 1.

When the command system 1 receives power from the notifier, the sound analysis device 10 (20, 30, 40) receives a sound signal input to a communication device used by the notifier for notification via a telephone line or an Internet protocol (IP) line. The sound signal may include a background sound in addition to the voice of the notifier.

For example, the background sound includes information of a sound emitted from a sound source located at the occurrence site of an incident. Examples of the sound source are a person other than the notifier, an animal, a train, an automobile, a machine, a speaker, and an alarm. The background sound may include information on the geography (for example, urban areas, industrial areas, along roads, mountains, beaches) and the weather (for example, rain, wind, thunderstorm) of the occurrence site of the incident.

The sound analysis device 10 (20, 30, 40) performs sound analysis on the received sound signal. The sound analysis device 10 (20, 30, 40) transfers the received sound signal to the OA terminal 100 used by the operator (recipient). As a result, the sound analysis device 10 (20, 30, 40) can execute sound analysis on the sound signal without disturbing a call between the operator (recipient) and the notifier.

The sound analysis device 10 (20, 30, 40) may be a part of a command control device that controls a command line of the command system 1 and achieves a function of the command system 1.

The function of the sound analysis device 10 (20, 30, 40) will be described in detail in the first to fourth example embodiments described later.

### First Example Embodiment

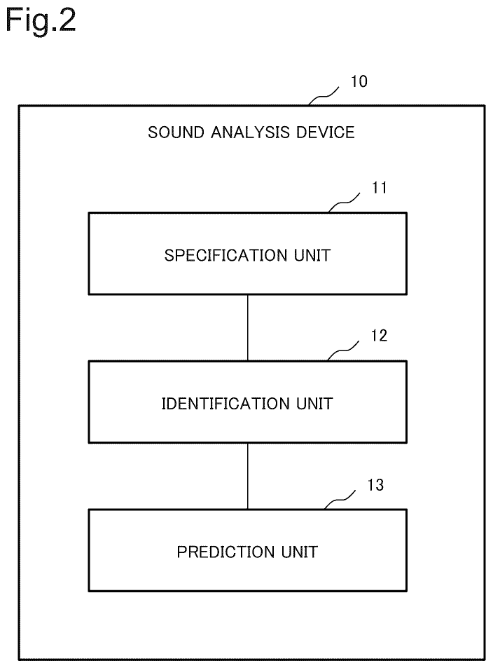

A first example embodiment will be described with reference to FIGS. 1 and 2.

### Sound Analysis Device 10

A configuration of the sound analysis device 10 according to the first example embodiment will be described with reference to FIG. 2. FIG. 2 is a block diagram illustrating a configuration of the sound analysis device 10.

As illustrated in FIG. 2, the sound analysis device 10 includes a specification unit 11, an identification unit 12, and a prediction unit 13.

The specification unit 11 specifies a non-voice time during which the notifier who notifies the occurrence of the incident is not speaking in the input sound signal. The specification unit 11 is an example of a specification means. The incidents include accidents such as traffic accidents and emergency diseases, as well as cases such as fire, flood damage, blackout, other disasters, appearance of wild animals, and crime. Generally, an emergency, fire, or police handling target is the incident here.

In one example, when there is a notification from the notifier to a telephone line (for example, No. 119) of the command system 1 (FIG. 1), the specification unit 11 receives the sound signal from a communication device of the notifier through the telephone line or the IP line. The sound signal includes a background sound in addition to the voice of the notifier. For example, when the weather at the occurrence site of the incident is rain, the sound signal may include a rain sound as a background sound.

First, the specification unit 11 uses a noise removal technique such as a digital filter or a known noise removal algorithm to remove a component whose frequency does not change greatly with time from the sound signal. As a result, the specification unit 11 can remove noise from the sound signal.

Next, the specification unit 11 separates the voice of the notifier included in the sound signal from other sounds (that is, background sounds) by applying the sound source separation technology in the technical field of machine learning to the sound signal from which the noise has been removed. As a result, the specification unit 11 can distinguish between a time zone in which there is a voice of the notifier and a time zone in which there is no voice of the notifier in the sound signal.

The specification unit 11 specifies the time zone in which there is no voice of the notifier as a non-voice time in which the notifier is not speaking. As described above, the sound signal in the non-voice time may include the background sound.

The specification unit 11 outputs the sound signal in the non-voice time to the identification unit 12. Alternatively, the specification unit 11 may output information for specifying the non-voice time to the identification unit 12 together with the sound signal. In this case, the identification unit 12 to be described later extracts the sound signal in the non-voice time from the entire sound signal using the information specifying the non-voice time.

The identification unit 12 analyzes the sound signal in the non-voice time to identify the sound source at the occurrence site of the incident. The identification unit 12 is an example of an identification means.

In one example, the identification unit 12 receives the sound signal in the non-voice time from the specification unit 11. The identification unit 12 determines whether strong reverberation is included in the sound signal in the non-voice time. In a case where the sound signal in the non-voice time includes strong reverberation, the identification unit 12 identifies that the occurrence site of the incident is a closed space (for example, indoor). Meanwhile, in a case where the sound signal in the non-voice time does not include reverberation or has weak reverberation, the identification unit 12 identifies that the occurrence site of the incident is a semi-open space or an open space (for example, outdoor).

The identification unit 12 determines whether a feature sound is included in the sound signal in the non-voice time using the machine-learned model. The feature sound is a sound that can identify a sound source, and includes, for example, a traveling sound of a train or an automobile, an announcement voice at a station platform, a sound of a traffic light for a person with visual disability, a sound or music repeatedly reproduced in a chain store such as an electric appliance store or a grocery store, and noise or scream of a crowd.

The identification unit 12 identifies the sound source based on the feature sound included in the sound signal. The identification unit 12 may identify a sound source of a sound related to an acceptance guideline for the occurred incident. The acceptance guideline defines a basic procedure for accepting an incident from notification or the like. The acceptance guideline may be different for each type of the incident. For example, the acceptance guideline when the incident is an emergency is different from the acceptance guideline when the incident is a fire. Therefore, the sound source identified by the identification unit 12 may be different depending on the type of the incident.

The identification unit 12 outputs the identification result of the sound source to the prediction unit 13. The identification result of the sound source includes information indicating the sound source identified from the sound signal in the non-voice time.

The prediction unit 13 predicts a sound scene at the occurrence site of the incident occurs based on the identified sound source. The prediction unit 13 is an example of a prediction means. The sound scene means a sight or a scene implied by the sound signal. The sound scene includes a situation, an environment, and an action of a person at the occurrence site of the incident.

In one example, the prediction unit 13 receives the identification result of the sound source from the identification unit 12. The prediction unit 13 extracts information indicating the identified sound source from the sound signal in the non-voice time from the identification result of the sound source. The prediction unit 13 refers to a database (not illustrated) that stores a table that associates the sound source with the sound scene. Then, the prediction unit 13 compares the sound source described in the table with the sound source identified from the sound signal in the non-voice time, thereby predicting the sound scene at the occurrence site of the incident.

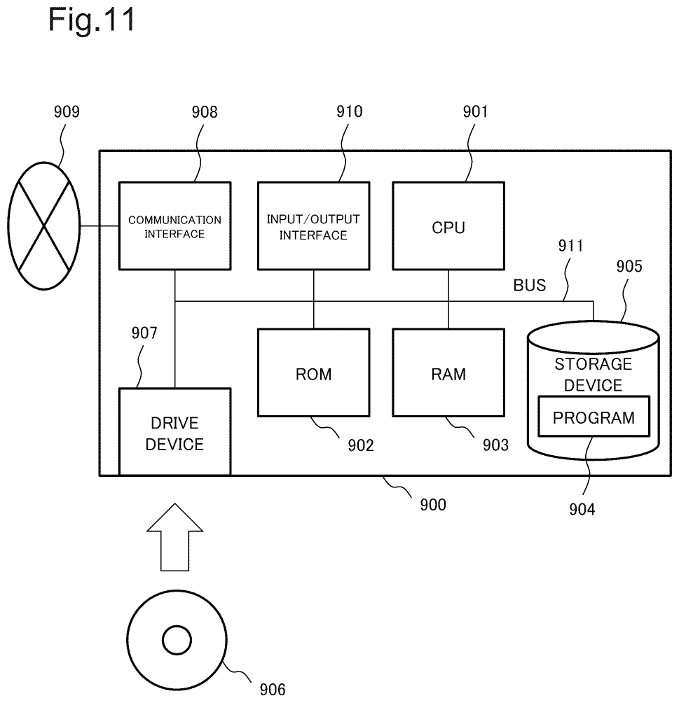

Thereafter, the prediction unit 13 may display information based on the predicted sound scene on the OA terminal 100 (FIG. 1) (second example embodiment). Alternatively, the prediction unit 13 may record information indicating the predicted sound scene in a recording medium such as a ROM 902 (FIG. 11).

### Operation of Sound Analysis Device 10

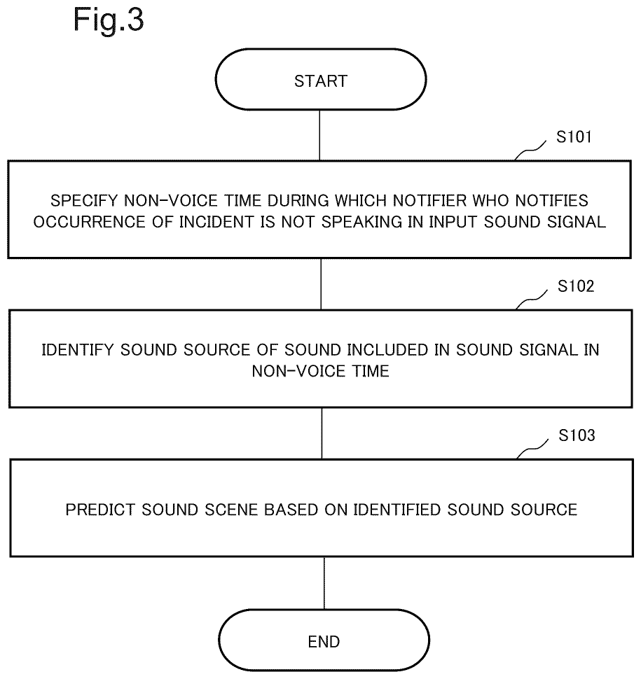

The operation of the sound analysis device 10 according to the first example embodiment will be described with reference to FIG. 3. FIG. 3 is a flowchart illustrating a flow of processing executed by each unit of the sound analysis device 10.

As illustrated in FIG. 3, the specification unit 11 specifies a non-voice time during which the notifier who notifies the occurrence of the incident is not speaking in the sound signal input to the command system 1 (FIG. 1) (S101).

The specification unit 11 outputs the sound signal in the non-voice time to the identification unit 12.

Next, the identification unit 12 identifies the sound source of the sound included in the sound signal in the non-voice time (S102).

The identification unit 12 outputs the identification result of the sound source to the prediction unit 13. The identification result of the sound source includes information indicating the sound source identified from the sound signal in the non-voice time.

Thereafter, the prediction unit 13 predicts the sound scene based on the identified sound source (S103).

Furthermore, the prediction unit 13 may display information based on the predicted sound scene on the OA terminal 100 (FIG. 1) (second example embodiment). Alternatively, the prediction unit 13 may record information indicating the predicted sound scene in a recording medium such as a ROM 902 (FIG. 11).

After Step S101, the specification unit 11 may output information for identifying the non-voice time to the identification unit 12 together with the sound signal. In this case, in Step S102, the identification unit 12 extracts the sound signal in the non-voice time from the entire sound signal using the information for specifying the non-voice time.

As described above, the operation of the sound analysis device 10 according to the first example embodiment ends.

### Effects of Present Example Embodiment

According to the configuration of the present example embodiment, the specification unit 11 specifies the non-voice time during which the notifier who notifies the occurrence of the incident is not speaking in the input sound signal. The identification unit 12 analyzes the sound signal in the non-voice time to identify the sound source at the occurrence site of the incident. The prediction unit 13 predicts a sound scene at the occurrence site of the incident occurs based on the identified sound source. In this manner, the sound scene at the occurrence site of the incident is predicted from the input sound signal. The recipient of the notification can grasp the situation, state, scene, environment, and the like of the occurrence site of the incident from the predicted sound scene. As a result, the recipient of the notification can quickly and accurately handle the incident.

### Second Example Embodiment

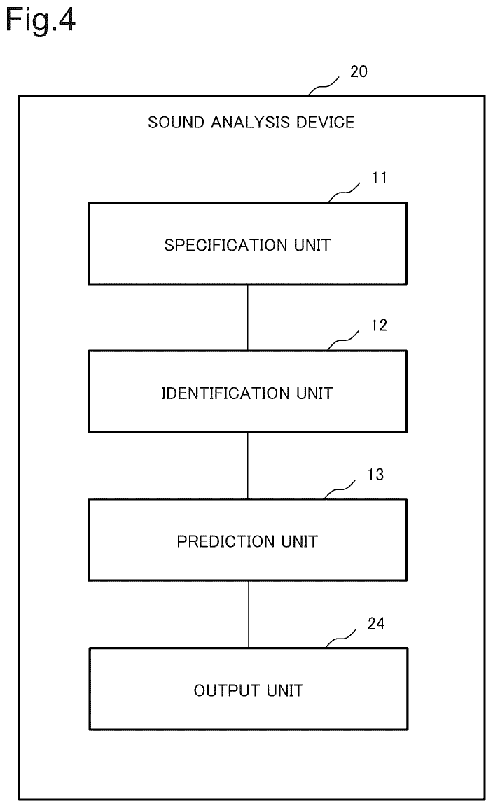

A second example embodiment will be described with reference to FIGS. 4 to 6. In the second example embodiment, a configuration will be described in which information indicating a situation, an environment, and an action of a person corresponding to a predicted sound scene is provided to a recipient of notification. In the second example embodiment, the configuration described in the first example embodiment is denoted by the same reference numeral as that of the first example embodiment, and description thereof is omitted.

### Sound Analysis Device 20

A configuration of a sound analysis device 20 according to the second example embodiment will be described with reference to FIG. 4. FIG. 4 is a block diagram illustrating a configuration of the sound analysis device 20.

As illustrated in FIG. 4, the sound analysis device 20 includes a specification unit 11, an identification unit 12, and a prediction unit 13. The sound analysis device 20 further includes an output unit 24.

The output unit 24 outputs information indicating the situation, environment, and action of the person corresponding to the predicted sound scene. The output unit 24 is an example of an output means.

In one example, the output unit 24 receives, from the prediction unit 13, information indicating a sound scene at the occurrence site of the incident. Alternatively, the output unit 24 acquires information indicating the predicted sound scene from a recording medium such as the ROM 902 (FIG. 11).

The output unit 24 generates information indicating the situation, the environment, and the action of the person at the occurrence site of the incident based on the information indicating the sound scene at the occurrence site of the incident. For example, the output unit 24 refers to a database (not illustrated) that stores a table that associates the sound scene with the situation, the environment, and the action of a person. Then, the output unit 24 determines the situation, the environment, and the action of the person at the occurrence site of the incident by comparing the sound scene described in the table with the sound scene at the occurrence site of the incident.

Then, the output unit 24 outputs information indicating the situation, the environment, and the action of the person at the occurrence site of the incident to the OA terminal 100 used by the operator (recipient) (FIG. 1).

By checking the information output to the OA terminal 100, the operator (recipient) can estimate the situation, the environment, and the action of the person corresponding to the predicted sound scene. Therefore, the operator (recipient) can more smoothly proceed the conversation with the notifier (FIG. 1).

### Example of Progress of Conversation between Operator and Notifier

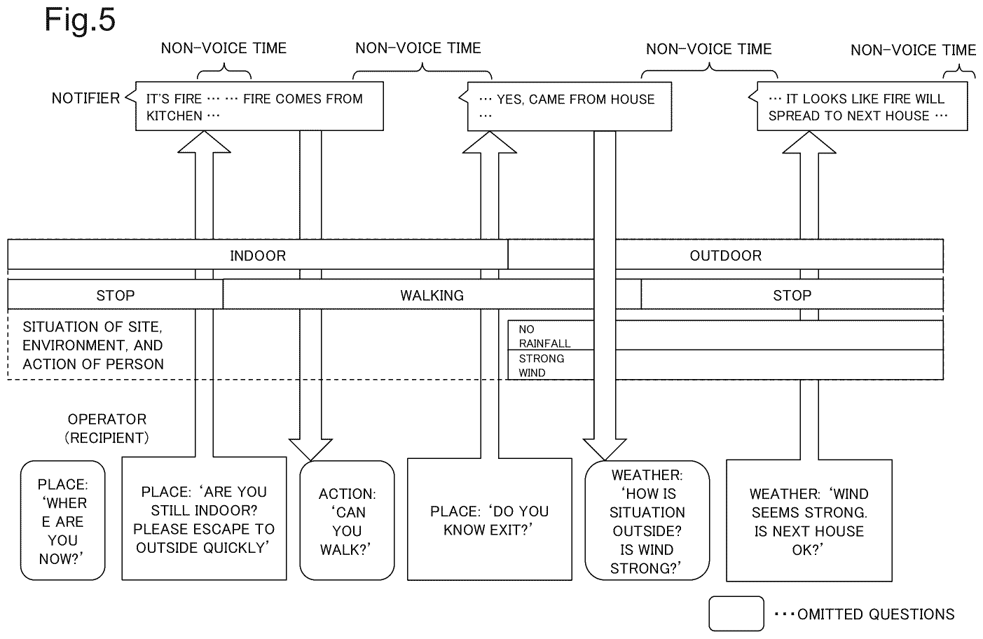

Information output from the output unit 24 according to the second example embodiment to the OA terminal 100 or the like will be described with reference to FIG. 5. FIG. 5 illustrates an example of the progress of a conversation between the operator (recipient) and the notifier at the time of occurrence of a fire (an example of an incident). FIG. 5 illustrates an example of information indicating the situation, environment, and action of the person at the occurrence site of the incident. A direction from left to right in FIG. 5 corresponds to a direction in which time advances.

In FIG. 5, an example of information indicating the situation, the environment, and the action of the person at the occurrence site of the incidents illustrated in a frame of a broken line at the center. An example of the statement of the notifier is illustrated in the upper portion. An example of the statement of the operator (recipient) is illustrated in the lower portion. An arrow extending upward from the frame surrounding the operator's statement indicates a question or confirmation from the operator (recipient) to the notifier. Meanwhile, an arrow extending downward from a frame surrounding the statement of the notifier indicates a response from the notifier to the operator (recipient).

As illustrated in FIG. 5, firstly, “indoor” is presented to the operator (recipient) by the output unit 24 as the information indicating the environment at the occurrence site of the incident. “stop” is presented to the operator (recipient) by the output unit 24 as the information indicating the action of the person at the occurrence site of the incident.

The operator (recipient) can know that the environment at the occurrence site of the incident is “indoor” by confirming the information output to the OA terminal 100. Therefore, the operator (recipient) does not need to ask the question ‘where are you now?’ in order to know the current location of the notifier. The operator (recipient) can omit the question ‘where are you now?’.

For example, the operator (recipient) asks a question ‘are you still indoor? please escape to the outside quickly’ to the notifier without asking a question about the current location of the notifier. The notifier can promptly start evacuation action in response to an instruction from an operator (recipient).

Secondly, “walking” is presented to the operator (recipient) by the output unit 24 as the information indicating the action of the person at the occurrence site of the incident. Therefore, the operator (notifier) does not need to ask the question ‘can you walk?’ in order to know whether the notifier can walk. The operator (recipient) can omit the question ‘can you walk?’.

For example, the operator (recipient) asks the notifier a question such as ‘do you know the exit?’. The notifier can promptly start evacuation action in response to an instruction from an operator (recipient).

Third, “outdoor” is presented to the operator (recipient) by the output unit 24 as the information indicating the environment at the occurrence site of the incident. “no rainfall” and “strong wind” are presented to the operator (recipient) by the output unit 24 as information indicating the weather at the occurrence site of the incident. Therefore, the operator (notifier) does not need to ask the question ‘how is the situation outside? is the wind strong?’ in order to know the weather at the occurrence site of the incident. The operator (recipient) can omit the question ‘how is the situation outside? is the wind strong?’.

For example, the operator (recipient) can ask the notifier a question such as ‘the wind seems strong. is the next house OK?’. The notifier answers the question from the operator (recipient).

In this manner, the operator (recipient) can omit some questions to the notifier by referring to the information presented by the output unit 24. Accordingly, the conversation with the notifier can be promptly advanced, and the instruction to the notifier can be accurately performed.

### Operation of Sound Analysis Device 20

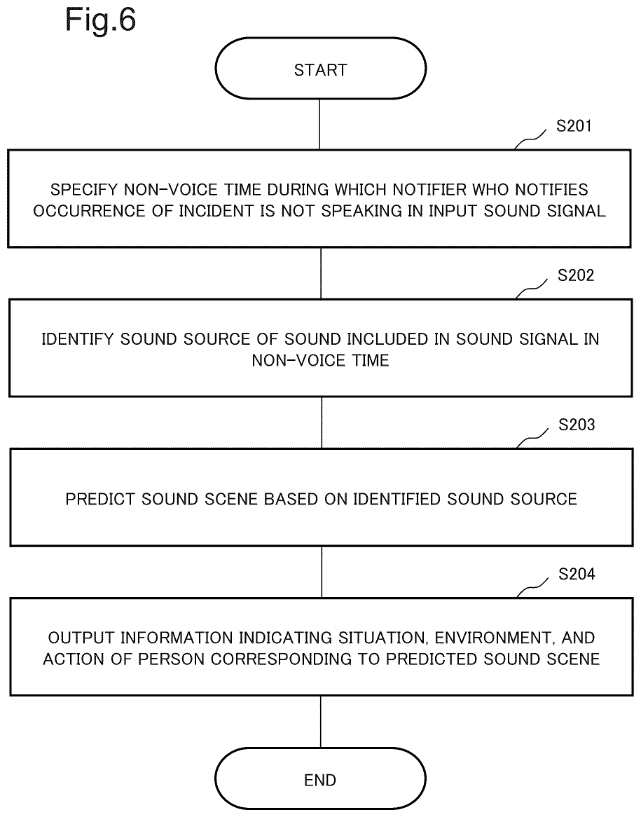

The operation of the sound analysis device 20 according to the second example embodiment will be described with reference to FIG. 6. FIG. 6 is a flowchart illustrating a flow of processing executed by each unit of the sound analysis device 20.

As illustrated in FIG. 6, the specification unit 11 specifies the non-voice time during which the notifier who notifies the occurrence of the incident is not speaking in the sound signal input to the command system 1 (FIG. 1) (S201).

The specification unit 11 outputs the sound signal in the non-voice time to the identification unit 12.

Next, the identification unit 12 identifies the sound source of a sound included in the sound signal in the non-voice time (S202).

The identification unit 12 outputs the identification result of the sound source to the prediction unit 13. The identification result of the sound source includes information indicating the sound source identified from the sound signal in the non-voice time.

Thereafter, the prediction unit 13 predicts the sound scene based on the identified sound source (S203).

Furthermore, the prediction unit 13 may record information indicating the predicted sound scene in the recording medium such as the ROM 902 (FIG. 11).

After Step S201, the specification unit 11 may output information for identifying the non-voice time to the identification unit 12 together with the sound signal. In this case, in Step S202, the identification unit 12 extracts the sound signal in the non-voice time from the entire sound signal using the information for specifying the non-voice time.

The prediction unit 13 outputs information indicating the predicted sound scene to the output unit 24.

The output unit 24 outputs information indicating the situation, the environment, and the action of the person corresponding to the predicted sound scene (S204).

As described above, the operation of the sound analysis device 20 according to the second example embodiment ends.

### Effects of Present Example Embodiment

According to the configuration of the present example embodiment, the specification unit 11 specifies the non-voice time during which the notifier who notifies the occurrence of the incident is not speaking in the input sound signal. The identification unit 12 analyzes the sound signal in the non-voice time to identify the sound source at the occurrence site of the incident. The prediction unit 13 predicts a sound scene at the occurrence site of the incident occurs based on the identified sound source. In this manner, the sound scene at the occurrence site of the incident is predicted from the input sound signal. The recipient of the notification can grasp the situation, state, scene, environment, and the like of the occurrence site of the incident from the predicted sound scene. As a result, the recipient of the notification can quickly and accurately handle the incident.

Furthermore, according to the configuration of the present example embodiment, the output unit 24 outputs information indicating the situation, the environment, and the action of the person corresponding to the predicted sound scene. As a result, it is possible to provide information indicating the situation, the environment, and the action of the person corresponding to the predicted sound scene to the recipient of the notification.

### Third Example Embodiment

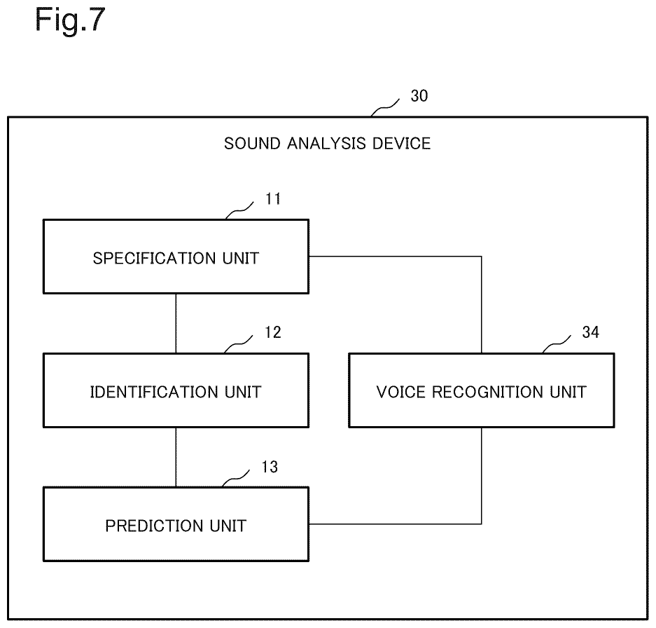

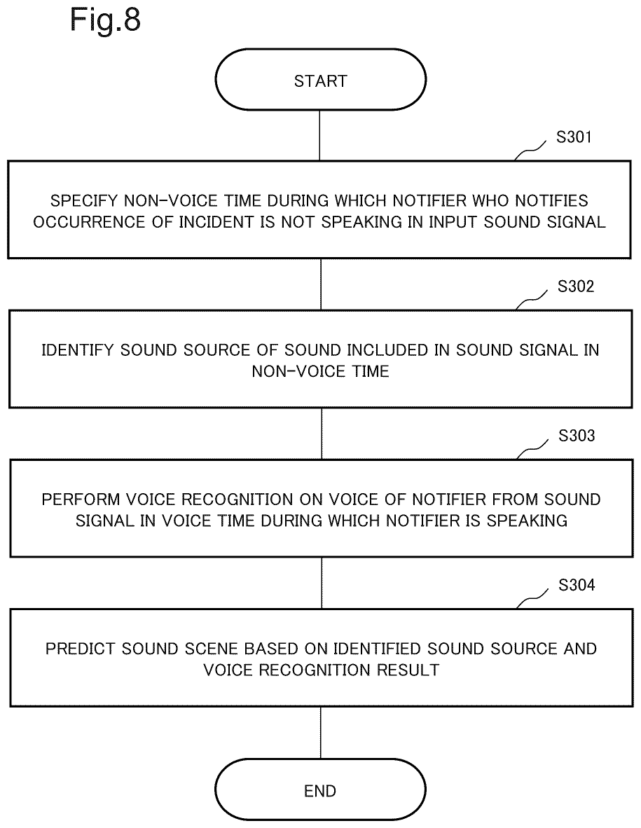

A third example embodiment will be described with reference to FIGS. 7 to 8. In the third example embodiment, a configuration for predicting a sound scene using a result of voice recognition of a notifier's voice in addition to an identified sound source will be described. In the third example embodiment, the configurations described in the first example embodiment or the second example embodiment are denoted by the same reference numerals as those in the first example embodiment or the second example embodiment, and description thereof will be omitted.

### Sound Analysis Device 30

A configuration of a sound analysis device 30 according to the third example embodiment will be described with reference to FIG. 7. FIG. 7 is a block diagram illustrating the configuration of the sound analysis device 30.

As illustrated in FIG. 7, the sound analysis device 30 includes a specification unit 11, an identification unit 12, and a prediction unit 13. The sound analysis device 30 further includes a voice recognition unit 34.

The voice recognition unit 34 performs voice recognition on a voice in a predetermined language from a sound signal in a voice time excluding a non-voice time in the input sound signal. The voice recognition unit 34 is an example of a voice recognition means.

In one example, the voice recognition unit 34 receives the sound signal in the voice time excluding the non-voice time from the specification unit 11. The voice recognition unit 34 analyzes the sound signal in the voice time using a voice recognition technology such as pattern matching or a language model (for example, recurrent neural network language model). As a result of the analysis, the voice recognition unit 34 obtains text data converted from the sound signal in the voice time. The text data is information of a sentence expressed in a predetermined language.

The subject of the voice recognized by the voice recognition unit 34 is usually the notifier, but the possibility of being other than the notifier is not excluded. This is because the sound signal in the voice time may include a voice of a person other than the notifier.

The voice recognition unit 34 outputs the text data converted from the sound signal in the voice time to the prediction unit 13.

In the third example embodiment, the prediction unit 13 predicts the sound scene at the occurrence site of the incident based on the result of recognizing the voice included in the sound signal by the voice recognition unit 34 in addition to the sound source identified from the sound signal. For example, the prediction unit 13 extracts a keyword (for example, fire, rain, train, etc.) from the result of recognizing the voice included in the sound signal. Then, the prediction unit 13 refers to a table that associates the preset keyword with the situation, environment, or action of the person, and specifies the situation, environment, or action of the person corresponding to the extracted keyword. The prediction unit 13 includes the specified situation, environment, or action of a person in an element for predicting the sound scene at the occurrence site of the incident. As a result, the prediction unit 13 can more accurately predict the sound scene at the occurrence site of the incident.

### Operation of Sound Analysis Device 30

The operation of the sound analysis device 30 according to the third example embodiment will be described with reference to FIG. 8. FIG. 8 is a flowchart illustrating a flow of processing executed by each unit of the sound analysis device 30.

As illustrated in FIG. 8, the specification unit 11 specifies the non-voice time during which the notifier who notifies the occurrence of the incident is not speaking in the sound signal input to the command system 1 (FIG. 1) (S301).

The specification unit 11 outputs the sound signal in the non-voice time to the identification unit 12. The specification unit 11 outputs the sound signal in the voice time other than the non-voice time to the voice recognition unit 34.

Next, the identification unit 12 identifies the sound source of a sound included in the sound signal in the non-voice time (S302).

The identification unit 12 outputs the identification result of the sound source to the prediction unit 13. The identification result of the sound source includes information indicating the sound source identified from the sound signal in the non-voice time.

The voice recognition unit 34 performs voice recognition on a voice in a predetermined language from the sound signal in the voice time excluding the non-voice time in the input sound signal (S303).

The voice recognition unit 34 outputs the text data converted from the sound signal in the voice time to the prediction unit 13.

Thereafter, the prediction unit 13 predicts the sound scene based on the identified sound source and the voice recognition result (S304).

Furthermore, the prediction unit 13 may display information based on the predicted sound scene on the OA terminal 100 (FIG. 1) (second example embodiment). Alternatively, the prediction unit 13 may record information indicating the predicted sound scene in a recording medium such as a ROM 902 (FIG. 11).

After Step S301, the specification unit 11 may output information for specifying the non-voice time to the identification unit 12 together with the sound signal. In this case, in Step S302, the identification unit 12 extracts the sound signal in the non-voice time from the entire sound signal using the information for specifying the non-voice time.

As described above, the operation of the sound analysis device 30 according to the third example embodiment ends.

### Modification

In a modification, the sound analysis device 30 may further include the output unit 24 (FIG. 4) described in the second embodiment. As in the second example embodiment, the output unit 24 outputs information indicating the situation, environment, and action of the person corresponding to the predicted sound scene. In addition, in the present third embodiment, the output unit 24 may further output a result of recognition of the voice included in the sound signal by the voice recognition unit 34. For example, the output unit 24 receives the text data converted from the sound signal in the voice time from the voice recognition unit 34. Then, the output unit 24 converts the received text data into image data of characters and displays the image data of characters on a screen of the OA terminal 100 (FIG. 1) or the like.

According to the configuration of the present modification, since the operator (recipient) can visually confirm the statement of the notifier using the OA terminal 100, it is possible to prevent erroneous recognition of the incident due to mishearing.

### Effects of Present Example Embodiment

According to the configuration of the present example embodiment, the specification unit 11 specifies the non-voice time during which the notifier who notifies the occurrence of the incident is not speaking in the input sound signal. The identification unit 12 analyzes the sound signal in the non-voice time to identify the sound source at the occurrence site of the incident. The prediction unit 13 predicts a sound scene at the occurrence site of the incident occurs based on the identified sound source. In this manner, the sound scene at the occurrence site of the incident is predicted from the input sound signal. The recipient of the notification can grasp the situation, state, scene, environment, and the like of the occurrence site of the incident from the predicted sound scene. As a result, the recipient of the notification can quickly and accurately handle the incident.

Furthermore, according to the configuration of the present example embodiment, the voice recognition unit 34 performs the voice recognition on a voice in a predetermined language from the sound signal in the voice time excluding the non-voice time in the input sound signal. In addition to the sound source identified from the sound signal, the prediction unit 13 predicts the sound scene at the occurrence site of the incident on based on the result of recognition of the voice included in the sound signal by the voice recognition unit 34. The prediction unit 13 includes the situation, the environment, or the action of the person specified from the voice recognition result in the element for predicting the sound scene at the occurrence site of the incident. As a result, the prediction unit 13 can more accurately predict the sound scene at the occurrence site of the incident.

### Fourth Example Embodiment

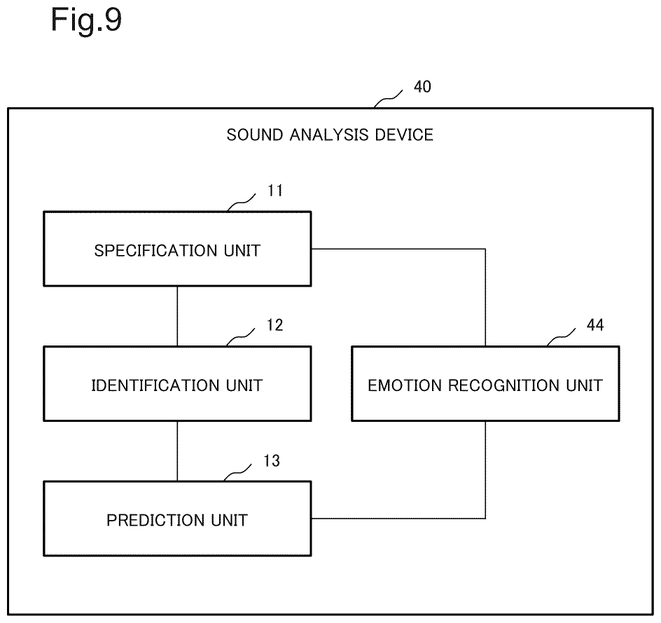

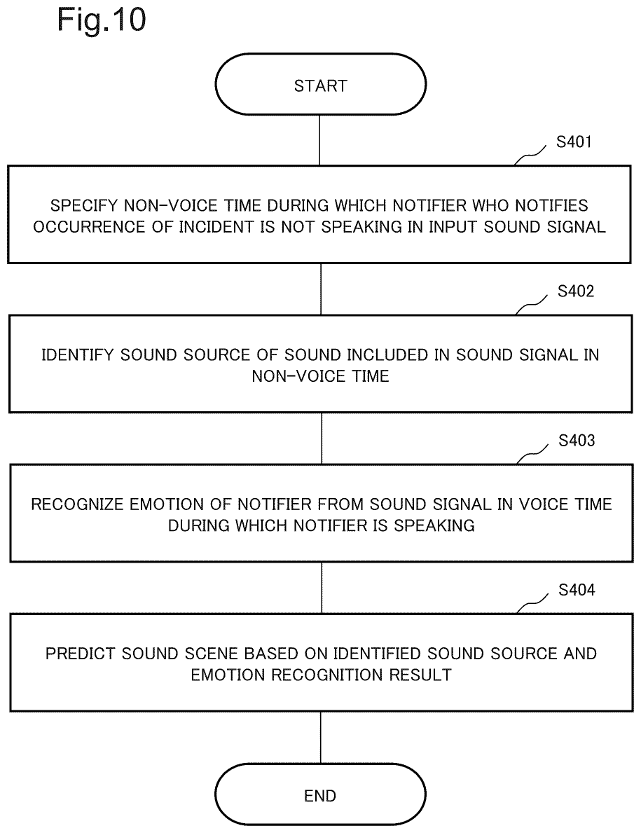

A fourth example embodiment will be described with reference to FIGS. 9 and 10. In the fourth example embodiment, a configuration for predicting a sound scene using a result of recognizing a feeling in addition to an identified sound source will be described. In the fourth example embodiment, the configuration described in at least one of the first to third embodiments is denoted by the same reference numeral as the first to third embodiments, and the description thereof will be omitted.

### Sound Analysis Device 40

A configuration of a sound analysis device 40 according to the fourth example embodiment will be described with reference to FIG. 9. FIG. 9 is a block diagram illustrating a configuration of the sound analysis device 40.

As illustrated in FIG. 9, the sound analysis device 40 includes a specification unit 11, an identification unit 12, and a prediction unit 13. The sound analysis device 40 further includes an emotion recognition unit 44.

The emotion recognition unit 44 recognizes the emotion from the sound signal in the voice time excluding the non-voice time in the input sound signal. The emotion recognition unit 44 is an example of an emotion recognition means.

In one example, the emotion recognition unit 44 receives the sound signal in the voice time excluding the non-voice time from the specification unit 11. The emotion recognition unit 44 analyzes the sound signal in the voice time using an emotion recognition technology such as emotion learning using a deep neural network (DNN). As a result of the analysis, the emotion recognition unit 44 obtains information indicating the emotion recognized from the sound signal in the voice time. The information indicating emotions indicates patterns of emotions such as “joy”, “sorrow”, and “anger”.

The subject of the emotion recognized by the emotion recognition unit 44 is usually the notifier, but the possibility of being other than the notifier is not excluded. This is because the sound signal in the voice time may include a voice of a person other than the notifier.

The emotion recognition unit 44 outputs information indicating the emotion recognized from the sound signal in the voice time to the prediction unit 13.

In the fourth example embodiment, in addition to the sound source identified from the sound signal, the prediction unit 13 predicts the sound scene at the occurrence site of the incident based on the result of the emotion recognition unit 44 recognizing the emotion. For example, the prediction unit 13 extracts an emotion pattern from the emotion recognition result. Then, the prediction unit 13 refers to a table that associates a preset emotion pattern with a situation, environment, or action of a person, and specifies a situation, environment, or action of a person corresponding to the extracted emotion pattern. The prediction unit 13 includes the specified situation, environment, or action of a person in an element for predicting the sound scene at the occurrence site of the incident. As a result, the prediction unit 13 can more accurately predict the sound scene at the occurrence site of the incident.

### Operation of Sound Analysis Device 40

The operation of the sound analysis device 40 according to the fourth example embodiment will be described with reference to FIG. 10. FIG. 10 is a flowchart illustrating a flow of processing executed by each unit of the sound analysis device 40.

As illustrated in FIG. 10, the specification unit 11 specifies the non-voice time during which the notifier who notifies the occurrence of the incident is not speaking in the sound signal input to the command system 1 (FIG. 1) (S401).

The specification unit 11 outputs the sound signal in the non-voice time to the identification unit 12. The specification unit 11 outputs the sound signal in the voice time other than the non-voice time to the emotion recognition unit 44.

Next, the identification unit 12 identifies the sound source of a sound included in the sound signal in the non-voice time (S402).

The identification unit 12 outputs the identification result of the sound source to the prediction unit 13. The identification result of the sound source includes information indicating the sound source identified from the sound signal in the non-voice time.

The emotion recognition unit 44 performs emotion recognition on a voice in a predetermined language from the sound signal in the voice time excluding the non-voice time in the input sound signal (S403).

The emotion recognition unit 44 outputs information indicating the emotion recognized from the sound signal in the voice time to the prediction unit 13.

Thereafter, the prediction unit 13 predicts the sound scene based on the identified sound source and the emotion recognition result (S404).

Furthermore, the prediction unit 13 may display information based on the predicted sound scene on the OA terminal 100 (FIG. 1) (second example embodiment). Alternatively, the prediction unit 13 may record information indicating the predicted sound scene in a recording medium such as a ROM 902 (FIG. 11).

After Step S401, the specification unit 11 may output information for specifying the non-voice time to the identification unit 12 together with the sound signal. In this case, in Step S402, the identification unit 12 extracts the sound signal in the non-voice time from the entire sound signal using the information for specifying the non-voice time.

As described above, the operation of the sound analysis device 40 according to the fourth example embodiment ends.

### Modification

In a modification, the sound analysis device 40 may further include the output unit 24 (FIG. 4) described in the second embodiment. As in the second example embodiment, the output unit 24 outputs information indicating the situation, environment, and action of the person corresponding to the predicted sound scene. In addition, in the fourth example embodiment, the output unit 24 may further output a result of the emotion recognition unit 44 recognizing the emotion. For example, the output unit 24 receives information indicating the state of the recognized emotion from the emotion recognition unit 44. Then, the output unit 24 converts the information received from the emotion recognition unit 44 into image data of symbols indicating the emotion state, and displays the image data of the symbols on the screen of the OA terminal 100 (FIG. 1) or the like.

According to the configuration of the present modification, since the operator (recipient) can visually confirm the state of the emotion recognized by the emotion recognition unit 44 using the OA terminal 100, it is possible to better communicate with the notifier and to more smoothly progress the conversation with the notifier.

### Effects of Present Example Embodiment

According to the configuration of the present example embodiment, the specification unit 11 specifies the non-voice time during which the notifier who notifies the occurrence of the incident is not speaking in the input sound signal. The identification unit 12 analyzes the sound signal in the non-voice time to identify the sound source at the occurrence site of the incident. The prediction unit 13 predicts a sound scene at the occurrence site of the incident occurs based on the identified sound source. In this manner, the sound scene at the occurrence site of the incident is predicted from the input sound signal. The recipient of the notification can grasp the situation, state, scene, environment, and the like of the occurrence site of the incident from the predicted sound scene. As a result, the recipient of the notification can quickly and accurately handle the incident.

Furthermore, according to the configuration of the present example embodiment, the emotion recognition unit 44 recognizes the emotion from the sound signal in the voice time during which the notifier is speaking. In addition to the sound source identified from the sound signal, the prediction unit 13 predicts the sound scene at the occurrence site of the incident based on a result of recognition of the emotion by the emotion recognition unit 44. The prediction unit 13 includes the situation, the environment, or the action of the person specified from the emotion recognition result in the element for predicting the sound scene at the occurrence site of the incident. As a result, the prediction unit 13 can more accurately predict the sound scene at the occurrence site of the incident.

### Regarding Hardware Configuration

Each component of the sound analysis devices 10, 20, 30, and 40 described in the first to fourth embodiments indicates a block of functional units. Some or all of these components are achieved by an information processing apparatus 900 as illustrated in FIG. 11, for example. FIG. 11 is a block diagram illustrating an example of a hardware configuration of the information processing apparatus 900.

As illustrated in FIG. 11, the information processing apparatus 900 includes the following configuration as an example.
CPU (Central Processing Unit) 901
ROM (Read Only Memory) 902
RAM (Random Access Memory) 903
Program 904 loaded to RAM 903
Storage device 905 storing program 904
Drive device 907 for reading and writing recording medium 906
Communication interface 908 connected to communication network 909
Input prediction interface 910 for performing input prediction of data
Bus 911 connecting each component

The components of the sound analysis devices 10, 20, 30, and 40 described in the first to fourth example embodiments are achieved by the CPU 901 reading and executing a program 904 that achieves these functions. The program 904 for achieving the function of each component is stored in the storage device 905 or the ROM 902 in advance, for example, and the CPU 901 loads the program into the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the sound analysis devices 10, 20, 30, and 40 described in the first to fourth embodiments are achieved as hardware. Therefore, an effect similar to the effect described in any one of the first to fourth embodiments can be obtained.

### SUPPLEMENTARY NOTE 1

One aspect of the present invention is also described as the following Supplementary Notes, but is not limited to the following.

### Supplementary Note 1

A sound analysis device including:
a specification means for specifying a non-voice time during which a notifier who notifies occurrence of an incident is not speaking in an input sound signal;
an identification means for identifying a sound source at an occurrence site of the incident by analyzing the sound signal in the non-voice time; and
a prediction means for predicting a sound scene at the occurrence site of the incident based on the identified sound source.

### Supplementary Note 2

The sound analysis device according to Supplementary Note 1, in which the sound scene includes a situation, an environment, and an action of a person at the occurrence site of the incident.

### Supplementary Note 3

The sound analysis device according to Supplementary Note 1 or 2, in which the identification means identifies a sound source of a sound related to an acceptance guideline for the occurred incident.

### Supplementary Note 4

The sound analysis device according to any one of Supplementary Notes 1 to 3, further including an output means for outputting information indicating a situation, an environment, and an action of a person corresponding to the identified sound scene.

### Supplementary Note 5

The sound analysis device according to any one of Supplementary Notes 1 to 3, further comprising a voice recognition means for performing voice recognition on a voice included in a sound signal in a voice time excluding the non-voice time in an input sound signal.

### Supplementary Note 6

The sound analysis device according to Supplementary Note 5, in which the prediction means predicts a sound scene at the occurrence site of the incident based on a result of recognition, by the voice recognition means, of a voice included in the sound signal in the voice time in addition to the sound source identified from the sound signal in the non-voice time.

### Supplementary Note 7

The sound analysis device according to any one of Supplementary Notes 1 to 3, further including an emotion recognition means for recognizing an emotion from a sound signal in a voice time excluding the non-voice time in an input sound signal.

### Supplementary Note 8

The sound analysis device according to Supplementary Note 7, in which the prediction means predicts a sound scene at the occurrence site of the incident based on the emotion recognized by the emotion recognition means from the sound signal in the voice time in addition to the sound source identified from the sound signal in the non-voice time.

### Supplementary Note 9

A sound analysis method including:
specifying a non-voice time during which a notifier who notifies occurrence of an incident is not speaking in an input sound signal;
identifying a sound source at an occurrence site of the incident by analyzing the sound signal in the non-voice time; and
predicting a sound scene at the occurrence site of the incident based on the identified sound source.

### Supplementary Note 10

A program for causing a computer to execute:
specifying a non-voice time during which a notifier who notifies occurrence of an incident is not speaking in an input sound signal;
identifying a sound source at an occurrence site of the incident by analyzing the sound signal in the non-voice time; and
predicting a sound scene at the occurrence site of the incident based on the identified sound source.

While the invention has been particularly illustrated and described with reference to example embodiments thereof, the invention is not limited to the above example embodiments. It will be understood by those of ordinary skill in the art that various changes in form and details may be made therein without departing from the spirit and scope of the present invention as defined by the claims

This application is based upon and claims the benefit of priority from Japanese patent application No. 2021-204070, filed on Dec. 16, 2021, the disclosure of which is incorporated herein in its entirety by reference.

### INDUSTRIAL APPLICABILITY

For example, in an emergency command system, the present invention can be used to provide information indicating an assistant at an occurrence site of an incident by analyzing a sound signal on a notifier side when the incident is notified.

### REFERENCE SIGNS LIST

1 command system
10 sound analysis device
11 specification unit
12 identification unit
13 prediction unit
20 sound analysis device
24 output unit
30 sound analysis device
34 Voice recognition unit
40 sound analysis device
44 emotion recognition unit
900 information processing apparatus
901 CPU
902 ROM
903 RAM
904 program
905 storage device
906 recording medium
907 drive device
908 communication interface
909 communication network

What is claimed is:

1. A sound analysis device comprising:
a memory configured to store instructions; and
at least one processor configured to execute the instructions to perform:
specifying a non-voice time during which a notifier who notifies occurrence of an incident is not speaking in an input sound signal;
identifying a sound source at an occurrence site of the incident by analyzing the sound signal in the non-voice time; and
predicting a sound scene at the occurrence site of the incident based on the identified sound source.

2. The sound analysis device according to claim 1, in which the sound scene includes a situation, an environment, and an action of a person at the occurrence site of the incident.

3. The sound analysis device according to claim 1, wherein
the at least one processor is configured to execute the instructions to perform: identifying a sound source of a sound related to an acceptance guideline for the occurred incident.

4. The sound analysis device according to claim 1, wherein
the at least one processor is further configured to execute the instructions to perform:
outputting information indicating a situation, an environment, and an action of a person corresponding to the identified sound scene.

5. The sound analysis device according to claim 1, wherein
the at least one processor is further configured to execute the instructions to perform:
performing voice recognition on a voice included in a sound signal in a voice time excluding the non-voice time in an input sound signal.

6. The sound analysis device according to claim 5, wherein
the at least one processor is configured to execute the instructions to perform:
predicting a sound scene at the occurrence site of the incident based on a result of recognition of a voice included in the sound signal in the voice time in addition to the sound source identified from the sound signal in the non-voice time.

7. The sound analysis device according to claim 1, wherein
the at least one processor is further configured to execute the instructions to perform:
recognizing an emotion from a sound signal in a voice time excluding the non-voice time in an input sound signal.

8. The sound analysis device according to claim 7, wherein
the at least one processor is configured to execute the instructions to perform:
predicting a sound scene at the occurrence site of the incident based on the emotion from the sound signal in the voice time in addition to the sound source identified from the sound signal in the non-voice time.

9. A sound analysis method comprising:
specifying a non-voice time during which a notifier who notifies occurrence of an incident is not speaking in an input sound signal;
identifying a sound source at an occurrence site of the incident by analyzing the sound signal in the non-voice time; and
predicting a sound scene at the occurrence site of the incident based on the identified sound source.

10. A non-transitory recording medium storing a program for causing a computer to execute:
specifying a non-voice time during which a notifier who notifies occurrence of an incident is not speaking in an input sound signal;
identifying a sound source at an occurrence site of the incident by analyzing the sound signal in the non-voice time; and
predicting a sound scene at the occurrence site of the incident based on the identified sound source.
